(19) United States
(12) Patent Application Publication
(10) Pub. No.: US 2004/0125696 A1
(43) Pub. Date: Jul. 1, 2004

(54) Method and installation for monitoring microseismic events

(76) Inventors: Robert Hughes Jones, Falmouth (GB); Ian S. Brown, Penzance (GB); Andrew John Jupe, Hayle (GB)

Correspondence Address: Bracewell & Patterson, L.L.P., P.O. Box 61389, Houston, TX, 77208-1389, US

(21) Appl. No.: 10/695,120

(22) Filed: Oct. 28, 2003

(30) Foreign Application Priority Data
Oct. 28, 2002 (GB) 0225048.8

(51) Int. Cl. G01V 1/00

(52) U.S. Cl. 367/14

(57) ABSTRACT

A method of monitoring microseismic events in a hydrocarbon production reservoir provided with a well comprising inner production tubing and an outer casing. The method includes providing one or more microseismic sensors in contact with the outer casing of the well, and taking steps to enhance the ability of the microseismic sensors to detect microseismic signals over the background noise generated by fluid flow inside the inner production tubing is enhanced. An installation suitable for carrying out such a method is also disclosed.

### RELATED APPLICATIONS

This application claims the benefit of United Kingdom Patent Application No. 0255048.8, filed on Oct. 28, 2002, which hereby is incorporated by reference in its entirety.

### TECHNICAL FIELD OF THE INVENTION

The present invention relates to a method and installation for monitoring microseismic events.

### BACKGROUND OF THE INVENTION

Microseismic events are of interest as they can provide information about fluid extraction from a hydrocarbon production reservoir or injection of fluid into the reservoir. The removal of oil or gas from the reservoir leads to stress equalisation processes, which can cause rock failure in the reservoir itself or in other underground cavities in the area, which in turn leads to an elastic wave propagating away from the source. Depending on the source mechanism, different proportions of the acoustic energy are shared between compressional (P-wave) and shear (S-wave) waves. During the waves transit, the P and S waves travel through the interposing vibrational media, such as different rock strata. Each rock type that the waves pass through has different P and S wave velocities and attenuation. By using a suitable arrangement of microseismic sensors (for example by using a triaxial arrangement of geophones or accelerometers and analysing the time lag between arrival of the P and S waves), it is possible via known techniques to locate the approximate location of the microseismic event.

While microseismic monitoring is well developed in some fields, for example that of mining and similar rock engineering activities, most microseismic work in the petroleum industry has to date been of a temporary nature, e.g. monitoring short-term operations such as fracturings or cuttings, or experimental nature, e.g. pilots for permanent systems. In most cases, where one or more production wells have already been constructed, measurements are conducted by locating one or more microseismic sensors inside one or more of the production wells.

In order to carry out a scan for microseismic events, it is important to identify a large number of signals in order to ensure that the data collected is correctly interpreted and applied to the reservoir management. Thus, where the microseismic sensors are located inside a production well, it normally becomes necessary to suspend production because, during operation, the production flow through the well tubing causes a relatively large amount of noise, which will swamp the microseismic signals which are, by comparison, inherently small. Without a good signal to noise ratio the number of microseismic signals detected reduces and with this goes speed and confidence of interpretation of microseismic events. Furthermore, noise can affect the event localisation accuracy and hence result in an unclear understanding of the results being obtained.

If production is not suspended, only those signals large enough to stand out above the background noise will be usable for the event localisation. This presents a serious problem, because, on the one hand, if production is not suspended it may take days or even weeks for sufficient numbers of signals to be obtained in order to obtain statistically relevant information, while on the other suspending production is a costly interruption for the oil company. Thus, it is in the interest of the petroleum industry to obtain a method of readily obtaining information about the effect of the extraction process on the reservoir while extraction is in progress.

The only permanent production designed sensor array tool that is currently available is that produced by Createch Industrie, of 91882 Massy, France. The latter's effectiveness is limited when in close proximity to the production tubing of a well because, as explained above, of the reduction in the number of events detectable over and above the background fluid flow noise. Likewise, determining the correct arrival time of P and S waves also becomes subject to errors.

U.S. Pat. No. 6,049,508 discloses a method of improving the chance of determining a significant microseismic event by avoiding spurious data from events directly connected with mechanical well operation, such as valve openings and closures. The method uses one or more sensors, such as geophones and hydrophones, and at least one reference pick-up, placed in contact with the production casing. However, it does not consider the difficulties posed by background flow noise.

A need exists for a method to determine microseismic activity at low levels without the need of shutting down production. A need also exists for the method and installation to be able to detect microseismic activity over a considerable amount of background noise.

### SUMMARY OF THE INVENTION

In view of the foregoing, the present invention advantageously provides methods of monitoring microseismic events in a hydrocarbon production reservoir provided with a well having inner production tubing and an outer casing and the installations required to perform such methods. The methods and installations described herein are capable of being used when during production, thereby eliminating the need to halt production to obtain reliable seismic data.

In a first embodiment, the method advantageously includes providing two or more microseismic sensors adjacent the outer casing of a well. Output from the sensors is then processed in order to provide the sensors with a directional response having a reduced sensitivity to sound coming from the direction of the production tubing. The ability of the sensors to detect microseismic signals over the background noise generated by fluid flow inside the production tubing is enhanced. The sensors can also be provided with a cardioid response.

According to the present invention from another aspect, there is provided a method of monitoring microseismic events in a hydrocarbon production reservoir provided with a well having inner production tubing and an outer casing. The method advantageously includes providing one or more first microseismic sensors adjacent the well casing of a well and providing one or more second microseismic sensors between the production tubing and the sensors located adjacent the casing. Output of the sensors nearer the tubing is advantageously processed in conjunction with the output of the sensors adjacent the casing such that the ability of the sensors adjacent the casing to detect microseismic signals over the background noise generated by fluid flow inside the production tubing is enhanced.

According to the present invention from another aspect, a method of monitoring microseismic events in a hydrocarbon production reservoir provided with a well comprising inner production tubing and an outer casing is advantageously provided. The method includes providing one or more microseismic sensors adjacent the well casing of a well and providing increased sound insulation between the sensors and the production tubing such that the ability of the sensors to detect microseismic signals over the background noise generated by fluid flow inside the production tubing is enhanced.

According to the present invention from another aspect, there is provided an installation for monitoring microseismic events in a hydrocarbon production reservoir provided with a well comprising inner production tubing and an outer casing, the installation comprising one or more microseismic sensors adjacent the well casing of the well and means for processing the output of the sensors in order to provide the sensors with a directional response comprising a reduced sensitivity to sound coming from the direction of the production tubing, such that the ability of the sensors to detect microseismic signals over the background noise generated by fluid flow inside the production tubing is enhanced.

According to the present invention from another aspect, there is provide an installation for monitoring microseismic events in a hydrocarbon production reservoir provided with a well comprising inner production tubing and an outer casing, the installation comprising one or more microseismic sensors adjacent the casing of the well, one or more microseismic sensors between the production tubing and the sensors located adjacent the casing of the well, and means for processing the output of the sensors nearer the tubing in conjunction with the output of the sensors adjacent the casing such that the ability of the sensors adjacent the casing to detect microseismic signals over the background noise generated by fluid flow inside the production tubing is enhanced.

According to the present invention from another aspect, there is provided an installation for monitoring microseismic events in a hydrocarbon production reservoir provided with a well comprising inner production tubing and an outer casing, the installation comprising one or more microseismic sensors adjacent the casing of the well and increased sound insulation between the sensors and the production tubing such that the ability of the sensors to detect microseismic signals over the background noise generated by fluid flow inside the production tubing is enhanced.

### BRIEF DESCRIPTION OF THE DRAWINGS

So that the manner in which the features, advantages and objects of the invention, as well as others which will become apparent, may be understood in more detail, more particular description of the invention briefly summarized above may be had by reference to the embodiment thereof which is illustrated in the appended drawings, which form a part of this specification. It is to be noted, however, that the drawings illustrate only a preferred embodiment of the invention and is therefore not to be considered limiting of the invention's scope as it may admit to other equally effective embodiments.

FIG. 1 is a simplified vertical section through a length of production well illustrating an installation for monitoring microseismic events;

FIG. 2 is a simplified vertical section through a length of production well illustrating an alternative installation for monitoring microseismic events;

FIG. 3 is a graph charting the polar response, at various discrete frequencies, of a sensor having a cardioid response; and

FIG. 4 is a graph charting the response versus frequency, at various discrete angles, of the same sensor.

### DETAIL DESCRIPTION OF THE PREFERRED EMBODIMENT

According to the present invention from one aspect, there is provided a method of monitoring microseismic events in a hydrocarbon production reservoir provided with a well having inner production tubing and an outer casing. The method advantageously includes providing two or more microseismic sensors adjacent the outer casing of a well. Output from the sensors is then processed in order to provide the sensors with a directional response having a reduced sensitivity to sound coming from the direction of the production tubing. The ability of the sensors to detect microseismic signals over the background noise generated by fluid flow inside the production tubing is enhanced. The sensors can also be provided with a cardioid response.

According to the present invention from another aspect, there is provided a method of monitoring microseismic events in a hydrocarbon production reservoir provided with a well having inner production tubing and an outer casing. The method advantageously includes providing one or more microseismic sensors adjacent the well casing of a well and providing one or more microseismic sensors between the production tubing and the sensors located adjacent the casing. Output of the sensors nearer the tubing is advantageously processed in conjunction with the output of the sensors adjacent the casing such that the ability of the sensors adjacent the casing to detect microseismic signals over the background noise generated by fluid flow inside the production tubing is enhanced.

According to the present invention from another aspect, a method of monitoring microseismic events in a hydrocarbon production reservoir provided with a well comprising inner production tubing and an outer casing is advantageously provided. The method includes providing one or more microseismic sensors adjacent the well casing of a well and providing increased sound insulation between the sensors and the production tubing such that the ability of the sensors to detect microseismic signals over the background noise generated by fluid flow inside the production tubing is enhanced.

Optionally, some or all of the above methods of monitoring for microseismic events may be combined, in order to further improve the ability of the sensors to detect microseismic signals over the background fluid flow noise. Where microseismic monitoring is to be conducted using sensors installed in more than one well, one or more of the above methods may be employed in each of the wells.

According to the present invention from another aspect, there is provided an installation for monitoring microseismic events in a hydrocarbon production reservoir provided with a well comprising inner production tubing and an outer casing, the installation comprising one or more microseismic sensors adjacent the well casing of the well and means for processing the output of the sensors in order to provide the sensors with a directional response comprising a reduced sensitivity to sound coming from the direction of the production tubing, such that the ability of the sensors to detect microseismic signals over the background noise generated by fluid flow inside the production tubing is enhanced.

According to the present invention from another aspect, there is provide an installation for monitoring microseismic events in a hydrocarbon production reservoir provided with a well comprising inner production tubing and an outer casing, the installation comprising one or more microseismic sensors adjacent the casing of the well, one or more microseismic sensors between the production tubing and the sensors located adjacent the casing of the well, and means for processing the output of the sensors nearer the tubing in conjunction with the output of the sensors adjacent the casing such that the ability of the sensors adjacent the casing to detect microseismic signals over the background noise generated by fluid flow inside the production tubing is enhanced.

According to the present invention from another aspect, there is provided an installation for monitoring microseismic events in a hydrocarbon production reservoir provided with a well comprising inner production tubing and an outer casing, the installation comprising one or more microseismic sensors adjacent the casing of the well and increased sound insulation between the sensors and the production tubing such that the ability of the sensors to detect microseismic signals over the background noise generated by fluid flow inside the production tubing is enhanced.

Optionally, the features of one of the above installations for monitoring for microseismic events may be combined with the features of one or both of the other installations, in order to further enhance the sensors abilities to detect microseismic signals over the background fluid flow noise.

As discussed above, where sensors are to be installed in production wells, sensor placement close to the flow-generated noise is inevitable. Thus a means of reducing the flow-generated noise acting on these sensors, and thus enhancing their ability to detect a microseismic event, is required.

Generically speaking, a number of different methods are possible in order to reduce the amount of noise received by a sensor. Noise reduction techniques can, broadly speaking, be divided into “active” and “passive” techniques.

Passive techniques involve insulating the sensor against the potential source of noise, for example by changes in cross-sectional area/material property leading to an increase in reflection/scattering, and/or adding an elastomeric inter-layer. In the context of attempting to reduce the amount of fluid flow noise reaching one or more sensors located against a well casing, solutions such as placing sound-absorbent material on the sensor housing on the side facing the flow noise, or surrounding the sensors with acoustic foam filled airspace, all involve passive attenuation of the fluid flow noise.

Active techniques consist of active noise control, beam-forming/null-steering. Both methods use signal processing to improve the signal to noise ratio, which in the context of the present invention means increasing the microseismic signal to flow noise ratio, such that the ability of the sensors to pick out the desired signals over the background noise is enhanced. These techniques will be explained more fully below, with reference to the following drawings.

How active and passive techniques are applied differs fundamentally. In the present context, since the creation of regions of quiet around the sensors is not of concern, the active techniques are applied to the signals only. In physical terms, all that is required is that the sensors be placed in the appropriate positions to ensure that the active techniques can be applied effectively. By comparison, passive techniques cannot easily be applied once the sensors have been positioned in the completed production well and so must usually be engineered in the design of the installation, for example by making suitable modifications to the sensor array housing, production tubing, well casing or fluid surrounding the production tubing.

Since passive techniques have a tendency to be more effective at higher frequencies and active techniques more effective at lower frequencies, a combination of both will in many cases be beneficial, in order to provide broadband attenuation of the noise signal. In some cases once the likely attenuation versus frequency for each type of active technique has been determined, the precise form and location that of passive attenuation that will be beneficial will be apparent, and thus an appropriate combination can then be easily decided upon. In some cases a combination of several types of one active and passive techniques may prove helpful (ie. a combination of active noise control, beam-forming/null-steering, and more than one type of insulation).

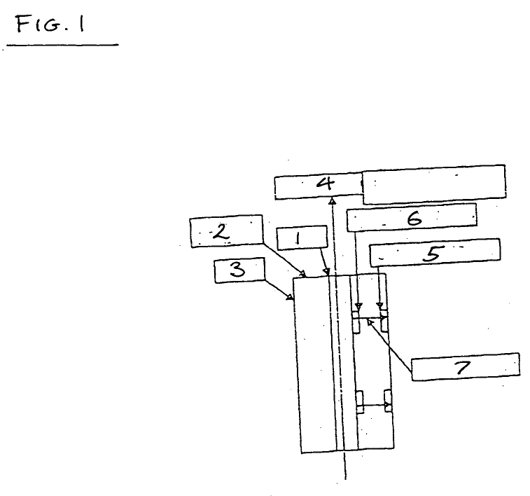

FIG. 1 shows, in simplified form, a vertical section of a length of production well, comprising a length of production tubing 1, surrounded by a fluid filled annulus 2 and well casing 3. In active production, fluid extracted from the hydrocarbon reservoir flows through the production tubing in the direction of arrow 4. A first pair of microseismic sensors 5 is mounted on the inside of the well casing 3, and a second pair of microseismic sensors 6 is mounted on the outside of the production tubing 1 facing the casing mounted sensors 5 and at approximately the same height. The signal outputs of the casing mounted sensors 5 and tubing mounted sensors 6 are connected to a data processing apparatus (not shown), which is preferably located topside. The data processing apparatus is adapted to simultaneously process the signal outputs of the casing 5 and tubing 6 mounted sensors, utilizing active noise control (ANC) techniques in order to improve the microseismic signal to fluid noise ratio.

ANC involves distinguishing a signal from the background noise at the frequency range of interest. It is most effective in simple cases, for example where the background noise originates from a slowly varying, periodic, noise sources from reciprocating engines and at low frequencies. If the source is periodic then it is possible to measure the background noise over one period, and generate the inverse and the appropriate transfer function. The sample rate is synchronized with the engines' rotation. The noise consists of the fundamental and a number of harmonics that are measured by a force transducer placed in series with the engine mounting points and the canceling source (vibrator).

Where the noise source is flow noise transmitted from the production tubing of an active well, the noise will not be so readily distinguishable from the microseismic signal. However, the presence of sensors 6 mounted against the production tubing allows the noise signal up-stream, i.e. closer to the noise source, from the casing mounted sensors 5 to be measured. By estimating the noise at the tubing mounted sensors 6, the transfer function between the tubing mounted sensors 6 and casing mounted sensors 5 (based on the expected noise path between the sensors, as indicated on FIG. 1 by arrow 7), and the time for sound to travel between the tubing 6 and casing 5 mounted sensors, it is then possible for the data processing apparatus to subtract the estimated flow noise at the casing mounted sensors 5 sensors from the output of the casing mounted sensors, thereby resulting in an improved ability to detect microseismic events during active production.

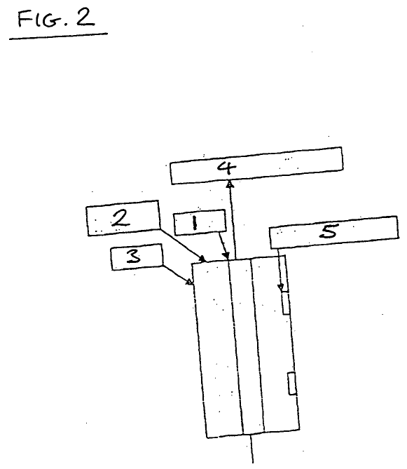

FIG. 2 shows, again in simplified form, a vertical section of a length of production well, with the production tubing, fluid filled annulus and casing bearing the same reference numbers as before. In the alternative installation shown, only casing mounted sensors 5 are required, with the topside data processing apparatus being programmed to process the signal outputs of the sensors 5 utilizing beam forming/null steering techniques, in order to improve the microseismic signal to fluid noise ratio.

Beam forming involves processing the signal outputs of a minimum of two sensors and applying a phase shift or time delay of one relative to the other in order to provide each sensor with a directional response in which the sensitivity of the sensor to sound is reduced in one or more directions, the angle over which sensitivity is substantially maintained being referred to as the sensor's beam and the angle over which sensitivity is substantially reduced being referred to as the null or beam minima. Null-steering involves then rotating the sensor's beam until the null is pointed in the direction in which sound is to ignored.

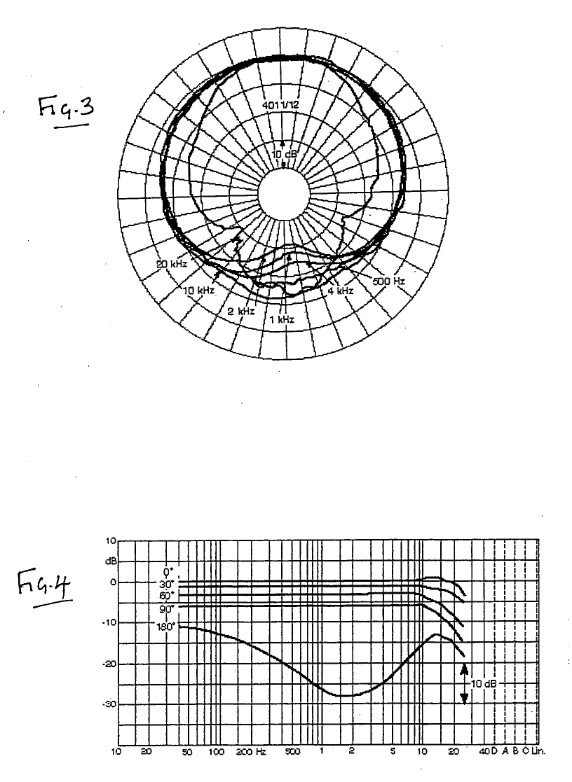

Thus, in the embodiment illustrated in FIG. 2, the data processor operates to maximize the signal to noise ratio by forming an appropriate directional response for each casing sensor 6, and then rotating the sensor's beam such that each sensor's null is pointed in the direction of the production tubing 1. It should be noted that it is not necessary that the casing mounted sensors 5 be directly adjacent each other, as sensor spacing will affect the final sensitivity of the sensors, with a trade-off of noise reduction against signal reduction being necessary.

Where omni-directional casing mounted sensors 5 are used, it is possible, using beam-forming, to convert their response from omni-directional to cardioid (i.e. to use beam-forming to create a cardioid beam). Referring now to FIGS. 3 and 4, FIG. 3 shows the polar response of a sensor having a cardioid response, at various frequencies, while FIG. 4 charts the change in response versus frequency of the same sensor at various angles. As the diagrams shown in FIGS. 3 and 4 represent in-air acoustics, the actual response obtainable by casing sensors in the production well environment may in some respects be quantitatively different in some respects, but in qualitative terms the same type of response should be obtainable. As both figures clearly show, the response of the sensor remains flat between + and −90 degrees except at high frequencies (above 10 kHz), while the response of the sensor in the 180 degree direction is significantly reduced, particularly in the 1 to 2 kHz range.

Thus, if the casing sensors 6 are provided with such a cardioid response, orientated such that the production tubing lies at null position (180 degrees in the case of the response illustrated in FIGS. 3 and 4), then it is clear that significantly less flow noise will be picked up by the sensors (particularly in the frequency ranges where attenuation at 180 degrees is significant). At the same time, while there will be some attenuation of microseismic signals originating from the 180 degree direction, the ability of the sensors to pick up microseismic signals originating from the + or −90 degree region will be largely unaffected, though at high frequencies some attenuation may occur as compared to what would be achieved if beam forming techniques had not been applied. Thus, overall the signal to noise ratio will be substantially improved.

As an advantage of the present invention, the present invention allows users to better determine seismic activity without having to disrupt or suspend production. The methods and installations described herein allow users to detect microseismic activity over background levels that are present without having to stop production.

While the invention has been shown or described in only some of its forms, it should be apparent to those skilled in the art that it is not so limited, but is susceptible to various changes without departing from the scope of the invention. For example, different types of sensors can be used for the microseismic sensors.

1. A method of monitoring microseismic events in a hydrocarbon production reservoir provided with a well comprising inner production tubing and an outer casing, said method comprising the steps of:
a) providing two or more microseismic sensors adjacent the outer casing; and
b) processing an output of the microseismic sensors in order to provide the microseismic sensors with a directional response comprising a reduced sensitivity to noise coming from a direction of the inner production tubing, such that an ability of the microseismic sensors to detect microseismic signals over a background noise generated by fluid flow inside the inner production tubing is enhanced.

2. A method according to claim 1, wherein step (b) comprises providing the microseismic sensors with a cardioid response.

3. A method according to claim 1, wherein two or more second microseismic sensors are also provided between the inner production tubing and microseismic sensors located adjacent the outer casing, output of the second microseismic sensors nearer the inner production tubing being processed in conjunction with output of the microseismic sensors adjacent the outer casing in order to further enhance an ability of the sensors adjacent the outer casing to detect microseismic signals over a fluid flow noise.

4. A method according to claim 1, wherein increased sound insulation is provided between the microseismic sensors located adjacent the outer casing and the inner production tubing in order to further enhance an ability of the microseismic sensors adjacent the outer casing to detect microseismic signals over a fluid flow noise.

5. A method of monitoring microseismic events in a hydrocarbon production reservoir provided with a well comprising an inner production tubing and an outer casing, the method comprising the steps of:
a) providing one or more first microseismic sensors adjacent the outer casing of the well;
b) providing one or more second microseismic sensors between the inner production tubing and the first microseismic sensors located adjacent the outer casing; and
c) processing output of the second microseismic sensors nearer the inner production tubing in conjunction with output of the first microseismic sensors adjacent the outer casing such that the ability of the first microseismic sensors to detect microseismic signals over a background noise generated by fluid flow inside the inner production tubing is enhanced.

6. A method according to claim 5, wherein increased sound insulation is provided between the casing sensors and the production tubing in order to further enhance the ability of the sensors adjacent the casing to detect microseismic signals over the fluid flow noise.

7. A method of monitoring microseismic events in a hydrocarbon production reservoir provided with a well comprising an inner production tubing and an outer casing, said method comprising:
a) providing one or more microseismic sensors adjacent the outer casing; and
b) providing increased sound insulation between the microseismic sensors and the inner production tubing such that an ability of the microseismic sensors to detect microseismic signals over a background noise generated by fluid flow inside the inner production tubing is enhanced.

8. An installation for monitoring microseismic events in a hydrocarbon production reservoir provided with a well comprising an inner production tubing and an outer casing, the installation comprising one or more first microseismic sensors adjacent the outer casing and means for processing an output of the first microseismic sensors in order to provide the first microseismic sensors with a directional response comprising a reduced sensitivity to noise coming from a direction of the inner production tubing, such that an ability of the first microseismic sensors to detect microseismic signals over a background noise generated by fluid flow inside the inner production tubing is enhanced.

9. An installation according to claim 8, further including one or more second microseismic sensors positioned between the inner production tubing and the first microseismic sensors located adjacent the outer casing of the well, and means for processing an output of the second microseismic sensors in conjunction with an output of the first microseismic sensors such that an ability of the first microseismic sensors to detect microseismic signals over a background noise generated by fluid flow inside the inner production tubing is enhanced.

10. An installation according to claim 8, further including increased sound insulation between the microseismic sensors and the inner production tubing such that an ability of the microseismic sensors to detect microseismic signals over a background noise generated by fluid flow inside the inner production tubing is enhanced.
